(19) United States
(12) Patent Application Publication
(10) Pub. No.: US 2004/0249900 A1
(43) Pub. Date: Dec. 9, 2004

(54) System and method for on-demand instant message expiration

(75) Inventor: Christopher K. Karstens, Apex, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/408,207

(22) Filed: Apr. 4, 2003

(51) Int. Cl. G06F 15/16

(52) U.S. Cl. 709/207

(57) ABSTRACT

A system and method for on-demand instant message expiration is presented. A source sends an instant message to a target over a computer network. The target receives the message, initiates an instant messaging session by displaying a session window on the target's display, and generates a session entry corresponding to the source and the instant messaging session. When the target does not respond to the source, the source sends an expiration request to the target. The target receives the expiration request, removes the instant message from the session window, and sends an acknowledgement to the source indicating that the message was removed. The source may send a global expiration request wherein the target removes a source's messages for each active instant messaging session.

### BACKGROUND OF THE INVENTION

1. Technical Field

The present invention relates in general to a system and method for on-demand instant message expiration. More particularly, the present invention relates to a system and method for a source to send an instant message to a target and the source subsequently sending an expiration request to the target that requests the target to remove the instant message from the target's display.

2. Description of the Related Art

Email is replacing the telephone as a preferred method of communication between individuals. However, email may not be a responsive form of communication for particular situations. For example, a user may require an immediate answer to a question, such as “The meeting has started, are you attending?” In this example, an email recipient may be working on a document and may not have his email account active.

Instant messaging has gained popularity, in part, because a user has an indication of whether a recipient will receive an instant message in a timely manner. The user accomplishes this by checking whether the recipient is logged into an instant messaging server. The instant messaging server handles instant messages that a source sends to a target and informs a source as to which targets included in a source's buddy list are logged on to the instant messaging server.

A challenge found, however, is that a source that sends an instant message to a target is not able to subsequently delete the instant message from the target's display when the target does not respond to the instant message. For example, a user may send an instant message that includes a question to two of his colleagues. The first colleague may be at a meeting and may not be able to respond to the user for a few hours. In the meantime, the second colleague sends a response to the user that answers his question. The user does not want to cause undue work for the first colleague and would like to delete the instant message from the first colleague's display.

What is needed, therefore, is a system and method for a source to remove an instant message from a target's display when the target does not respond to the instant message.

### SUMMARY

It has been discovered that the aforementioned challenges are resolved by tracking an instant message that a target has not replied, and sending an expiration request to the target to remove the corresponding message. A source sends an instant message to a target using a session window. Subsequently, the source's user wishes to remove the instant message from the target and sends an expiration request to the target. The target removes the instant message from the target's display and sends an expiration acknowledgement to the source which indicates that the message has been removed at the target.

A source sends an instant message to a target. For example, a user may send a question to one of his colleagues and wishes to receive an immediate response. The target receives the instant message and determines whether the instant message belongs to an existing session between the source and the target, or whether the instant message is a first message of a new session. The target determines that the instant message is a first message of a new session, opens a new session window, displays the instant message in the session window, and adds a session entry to a session table located in a nonvolatile storage area.

In one embodiment, named “Message Level” mode, the target adds a session entry to the session table for each message that is received from the source. In another embodiment, named “Summary Level” mode, the target updates the same session entry in the session table for each subsequent message that is received from the source. In these embodiments, the source selects a “Message Level” or “Summary Level” mode for each instant message and includes a “Level” identifier, such as a command code, in the instant message for the target to evaluate. In these embodiments, the target examines the “Level” identifier to determine if the received instant message corresponds to a “Message Level” or “Summary Level” mode.

The session entry includes session entry fields such as a source identifier, an expiration time, a last response threshold, and a conversation state flag. The source identifier field includes an identifier corresponding to the source of an instant message. The expiration time field includes a time set by the source whereby, at the expiration time, the target deletes the message if the target has not responded to the message. The last response threshold field includes a time set by the target whereby, at the last response threshold time, the target deletes the message if the target has not responded to the message.

The target extracts the expiration time from the instant message and adds the expiration time to the session entry. The target identifies a last response threshold using the target's user configuration settings and adds the last response threshold to the session entry. For example, the target's user may configure a last response threshold of “fifty minutes”. The session entry's conversation state flag is default to “n” (e.g. not replied) until the target replies to the instant message, whereupon the conversation state flag is changed to “r” (e.g. replied).

The target does not respond to the instant message and, as such, the session entry's conversation flag remains set at “n”. For example, the target's user may be in an afternoon meeting and is not presently at his desk. The source's user uses a session window to send an expiration request to the target requesting the target to remove the instant message from the target's display. The target receives the expiration request and looks-up a corresponding session entry in the session table. The target identifies the session entry corresponding to the source, and removes the instant message from the target's display. The target determines whether instant messages other than those originating from the source exist. If no other messages exist, the target closes the corresponding session window. If other messages exist (e.g. originating from other sources), the target does not close the session window. The target may display a message which informs the target's user that messages have been removed by the source on the target's display.

The target sends an expiration acknowledgement to the source which includes information as to the number of messages the target removed from its display. For example, if the source sent five messages, the target removes each message from its display and sends an acknowledgement message to the source indicating that the target removed five messages. When the source receives the expiration acknowledgement, the source displays a message on its display that informs its user that instant messages were successfully removed from the target's display.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a source sending an instant message to targets and the source expiring the instant message at one of the targets;

FIG. 2A is a session window showing various user interface areas;

FIG. 2B is a session window showing results of a source sending an instant message to two targets;

FIG. 2C is a session window showing a source expiring a target's instant message located at the target;

FIG. 3 is a high-level flowchart showing steps taken in a source sending an instant message to a target and the source subsequently expiring the instant message at the target;

FIG. 4 is a flowchart showing steps taken in a source sending an instant message to a target;

FIG. 5 is a flowchart showing steps taken in a target processing a message that is sent by a source;

FIG. 6 is a flowchart showing steps taken in a source sending an expiration request to a target; FIG. 7 is a flowchart showing steps taken in a target processing an expiration request;

FIG. 8 is a flowchart showing steps taken in a target replying to an instant message;

FIG. 9 is a flowchart showing steps taken in a source processing a target's reply;

FIG. 10 is a flowchart showing steps taken in a target processing existing session entries and removing session entries that have expired; and I FIG. 11 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

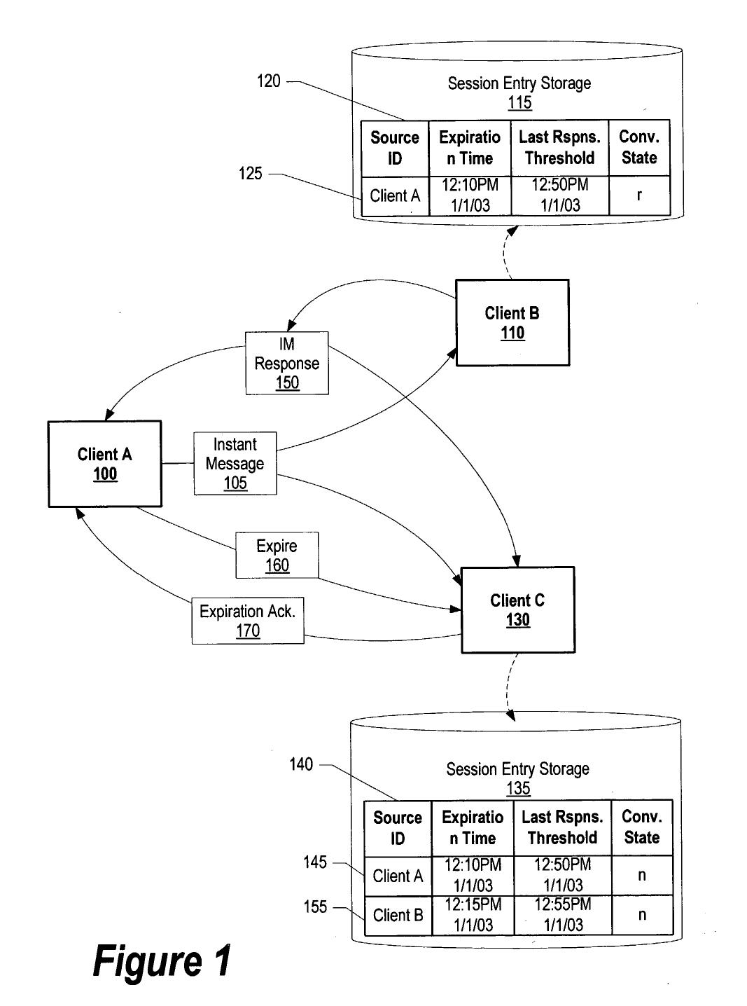

FIG. 1 is a diagram showing a source sending an instant message to targets and the source expiring the instant message at one of the targets. Client A 100 (e.g. source) wishes to send an instant message to client B 110 and client C 130 (e.g. targets). For example, a user may wish to send a question to two of his colleagues and requires an immediate response. Client A 100 sends instant message 105 to client 110 B and client C 130. In one embodiment, client A 100 sends instant message 105 to client B 110 and client C 130 over a computer network, such as the Internet.

Client B 110 receives instant message 105 and determines whether instant message 105 belongs to an existing session between client A 100 and client B 110, or whether instant message 105 is a first message of a new session. For example, client B 110 may use a session look-up table to identify existing sessions that correspond to particular clients. Client B 110 determines that instant message 105 is a first message of a new session, opens a new session window, displays the instant message in the session window, and adds session entry 125 to table 120 located in session entry storage 115. Session entry 125 includes session entry fields such as a source identifier (e.g. client A), an expiration time, a last response threshold, and a conversation state flag. The source identifier field includes an identifier corresponding to the source of an instant message. The expiration time field includes a time set by the source whereby, at the expiration time, the target deletes a corresponding message if the target has not responded to the message. The last response threshold field includes a time set by the target whereby, at the last response threshold time, the target deletes a corresponding message if the target has not responded to the message.

Client B 110 extracts the expiration time from instant message 105 and includes the expiration time to session entry 125. Client B 110 identifies a last response threshold using the target's user configuration settings and includes the last response threshold to session entry 125. For example, client B 110's user may configure a last response threshold of “fifty minutes”. Session entry 125's conversation state flag is default to “n” (e.g. not replied) until client B 110 replies to the instant message, whereupon the conversation state flag is changed to “r” (e.g. replied). Session entry storage 115 may be stored on a non-volatile storage area, such as a computer hard drive, or a volatile storage area, such as volatile memory.

In one embodiment, client B 110 adds a session entry to table 120 for each message that it receives from client A 100. Client A 100 selects a “Message Level” mode to associate with the instant message which includes a “Level” identifier, such as a command code, in instant message 105 to inform client B 110 of the mode. In this embodiment, client B 110 examines the “Level” identifier and determines that the instant message corresponds to a “Message Level” mode.

In another embodiment, a source configures a level mode based upon a particular target. For example, a source's user may “right click” on a target identifier located in his buddy list and configures a level mode corresponding to the target identifier to “Message Level”. In this example, when the source sends an instant message to the particular target, the instant message includes a “Message Level” identifier.

Client C 130 also receives instant message 110 and identifies instant message 105 as a first message of a new session between client C 130 and client A 100. Client C 130 opens a new session window, displays the instant message in the session window, and adds session entry 145 to table 140 located in session entry storage 135. Session entry 145 includes session entry fields such as a source identifier, an expiration time, a last response threshold, and a conversation flag similar to session entry 125 as described above. Session entry 145, however, includes a last response threshold corresponding to client C 130's user configuration settings.

Client B 110's user is at his desk and sends instant message response 150 in response to instant message 105. Instant message response 150 is sent to each client in the session, such as client A 100 and client C 130. Client B 110 changes session entry 125's conversation state flag to “r” (e.g. replied) when it replies to instant message 105. When client C 130 receives instant message response 150, client C 130 adds session entry 155 to table 140 wherein session entry 155 includes client B 110's identifier. Client C 130 has not yet responded to instant message 105 and, as such, session entry 145's conversation flag remains set at “n”. For example, client C 130's user may be in an afternoon meeting and is not presently at his desk.

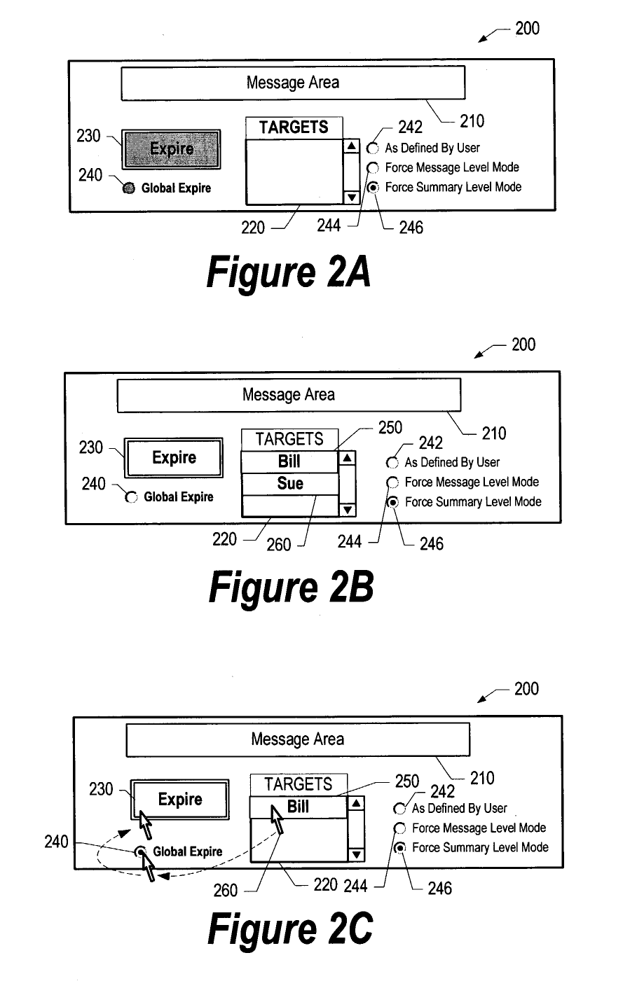

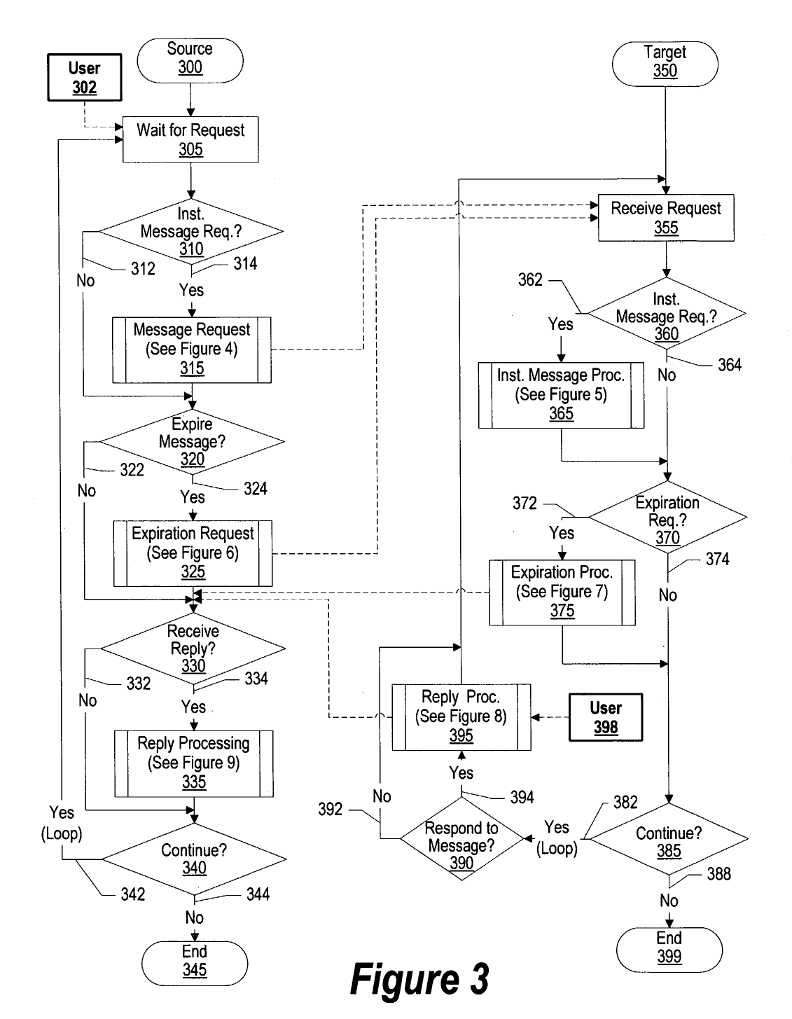

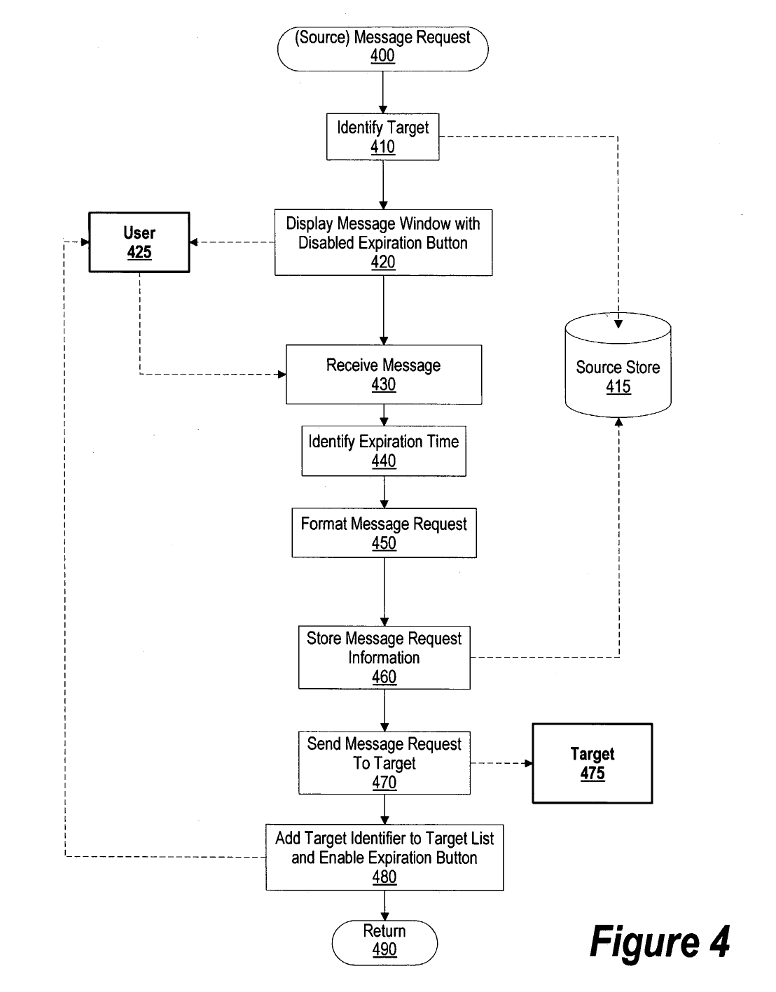

Client A 100 wishes to remove (i.e. expire) instant message 105 from client C 130's display since client B 100 provided an answer to client A 100's question. Using the example described above, client A 100 may not wish client C 130's user to spend time on providing client A 100 an answer to his question since client B 110 already provided an answer to his question. Client A 100 sends an expiration request, such as expire 160, to client C 130 (see FIGS. 2A, 2B, 2C, and corresponding text for further details regarding session windows). Client C 130 receives expire 160 and looks-up a session entry in table 140 that corresponds to client A 100. Client C 130 identifies session entry 145 and removes the instant message (e.g. instant message 105) from client C 130's display originating from client A 100. Client C 130 does not remove instant messages that originated from client B 110 (e.g. instant message response 150)(see FIG. 7 and corresponding text for further details regarding instant message removal). Client C 130 determines whether instant messages other than those originating from client A 100 exist. If no other messages exist, and the conversation flag for client A 100 is set to “n”, client C 130 closes the corresponding session window. If other messages exist (e.g. originated from client B 110), or the conversation flag for client A 100 is set to “r”, client C 130 does not close the session window (see FIG. 7 and corresponding text for further details regarding expiration request processing). In either case, client C 130 may display a message which informs client C 130's user that messages have been removed by client A 100 on client C 130's display. Client C 130 also removes session entry 145 from table 140.

Client C 130 sends expiration acknowledgement 170 to client A 100 which includes information as to the number of messages client C 130 removed from its display. For example, if client A 100 sent five messages, client C 130 removes each message from its display and sends an acknowledgement message to client A 100 indicating that client C 130 removed five messages from its display. When client A 100 receives expiration acknowledgement 170, client A 100 displays a message on its display that informs its user that instant messages were successfully removed on client C 130's display.

FIG. 2A is a session window showing various user interface areas. Window 200 is an instant messaging window in which a source displays when a user wishes to send or expire an instant message. Window 200 includes text box 210 which displays messages that are transmitted by the source as well as messages that the source receives from a target.

Window 200 also includes selection box 220 which displays target identifiers corresponding to targets that have not responded to the last instant message sent from the session window (see FIGS. 2B, 2C, and corresponding text for further details regarding target identifiers). A user selects one or more target identifiers in selection box 220 when the user wishes to expire an instant message at a target. The example in FIG. 2A shows that selection box 220 does not include a target identifier which indicates that the source either has not sent an instant message to a target or that the target has responded to the instant message.

Window 200 includes command button 230 that a user selects to send an expiration request to a target. Command button 230 is enabled when the source sends an instant message to a target and stays enabled until the target responds to the instant message, the source expires the instant message, or the target expires the instant message. The example in FIG. 2A shows that command button 230 is currently disabled.

Window 200 also includes radio button 240 that a user selects if the user wishes to expire each active session corresponding to a particular target. For example, a user may have four individual active sessions with “Target A” and the user wishes to expire each instant message associated with the four active sessions that “Target A” has not replied. Radio button 240 is enabled when command button 230 is enabled. The example in FIG. 2A shows that radio button 240 is disabled.

Window 200 includes radio buttons 242, 244, and 246 in which a user selects in order to configure a particular instant message for “Message” mode or “Summary” mode. The example in FIG. 2A shows that the user selects radio button 246 which configures instant messages in a “Summary” mode.

FIG. 2B is a session window showing results of a source sending an instant message to two targets. The source sent an instant message to targets “Bill” and “Sue” and added target identifiers 250 and 260 to selection box 220. The source also enabled command button 230 and radio buttons 240. The example in FIG. 2B shows that the user is able to expire the instant message located at target “Bill” until “Bill” responds to the instant message, or “Bill's” session expires the message. The same is true for Sue (see FIG. 2C and corresponding text for further details regarding instant message expiration).

In one embodiment, if a message is sent to a particular group, such as “Team Alpha”, group member targets may be shown in the selection box as a subset of “Team Alpha” such as shown below:

+Team Alpha

Bill

Sue

Initially, each group member appears under the group identifier. As targets respond or messages expire, their individual target identifiers are removed from under the group identifier in the selection box. In this embodiment, a user selects “+” to show or hide team members who have not replied and whose sessions have not expired the message. A user may also select “Team Alpha” to send an expiration request to each team member that has not responded to an instant message (see FIG. 2C and corresponding text for further details regarding expiration requests).

FIG. 2C is a session window showing a source expiring a target's instant message located at the target. The source sent an instant message to targets “Bill” and “Sue” (see FIG. 2B and corresponding text for further details). Target “Sue” responded to the instant message whereupon the source removed a target identifier “Sue” (e.g. target identifier 260 in FIG. 2B) from selection window 220. However, target “Bill” has not responded to the instant message and the source's user wishes to remove the instant message from target “Bill's” display.

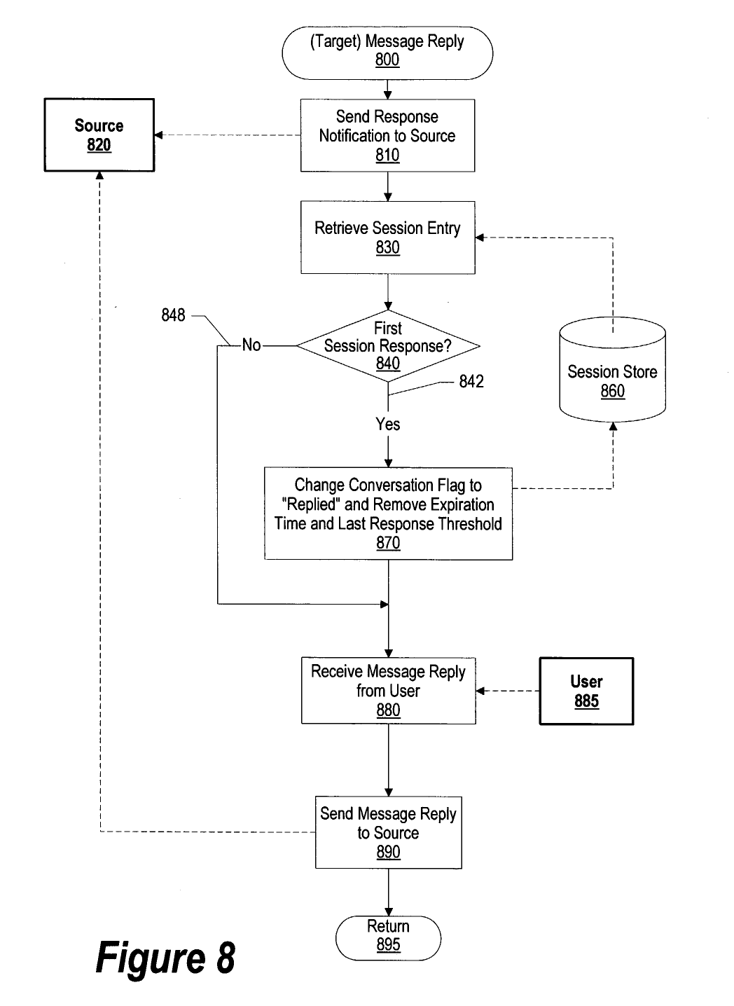

The user uses pointing device 260 to select target identifier 250 which corresponds to target “Bill”. The user then decides whether he wishes to remove instant messages for each active session or just a session corresponding to window 200. If the user wishes to remove instant messages for each active session, the user uses pointing device 260 to select radio button 240 to globally expire instant messages at target “Bill”. If the user does not wish to remove instant messages for each active session, -the user does not select radio button 240. The user then uses pointing device 260 to select command button 230. When the user selects command button 230, the source sends an expiration request to target “Bill”, removes target identifier 250 from selection box 220, disables command button 230, and disables radio button 240 (see FIG. 6 and corresponding text for further details regarding expiration request processing). As one skilled in the art can appreciate, a user may use keyboard commands (i.e. ALT-S, up/down arrows, etc.) in place of a pointing device to interface with window 200.

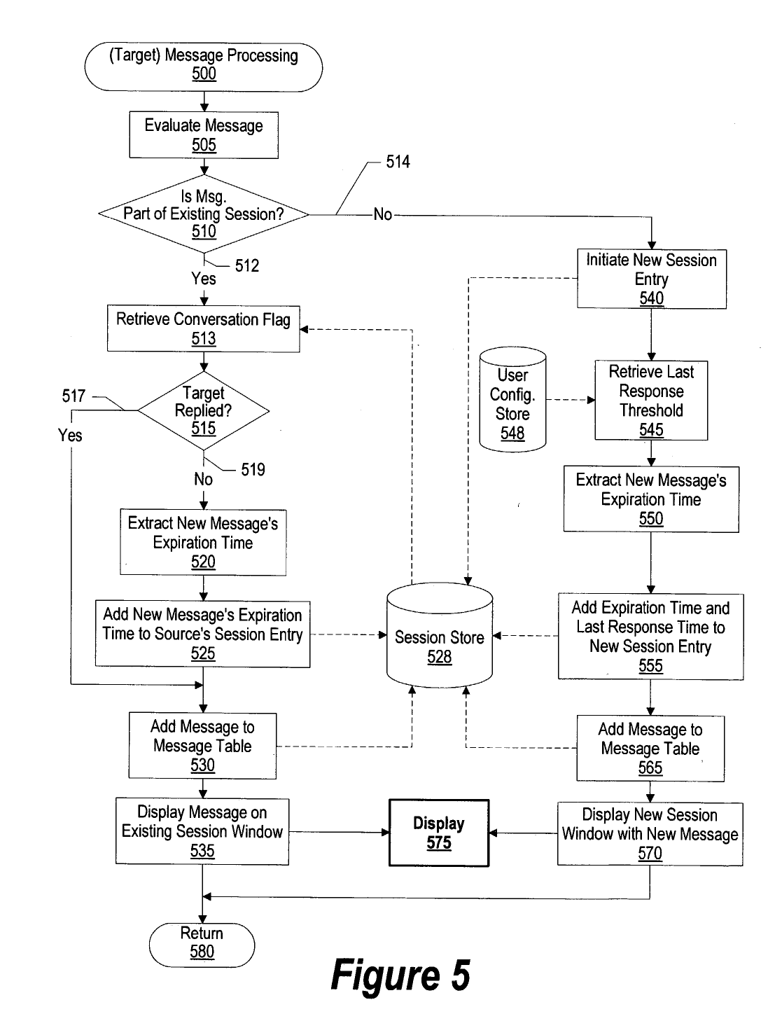

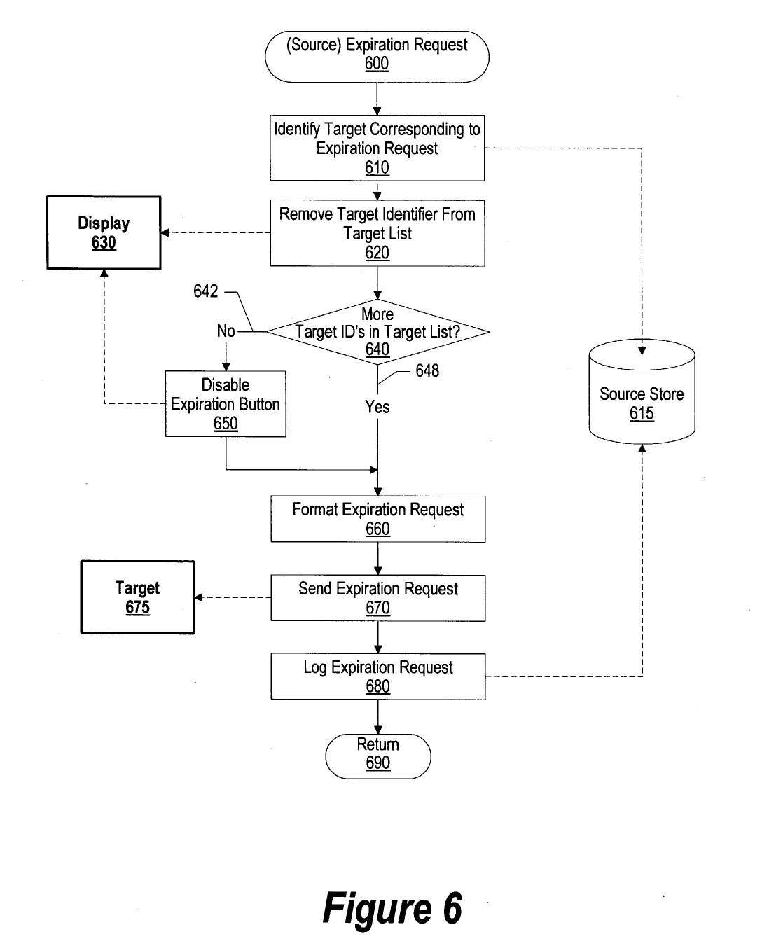

FIG. 3 is a high-level flowchart showing steps taken in a source sending an instant message to a target and the source subsequently expiring the instant message at the target. Source processing commences at 300, whereupon processing waits for request from user 302 at step 305. Once source processing receives a request from user 302, a determination is made as to whether the request is an instant message request (decision 310). For example, user 302 may wish to send an instant message to his work associate (i.e. target). If the user request is an instant message request, decision 310 branches to “Yes” branch 314 whereupon the request is processed and an instant message is sent to the target (pre-defined process block 315, see FIG. 4 and corresponding text for further details). On the other hand, if the request is not an instant message request, decision 310 branches to “No” branch 312 bypassing instant message-processing steps.

A determination is made as to whether user 302's request is an expiration request (decision 320). For example, the user may wish to expire an instant message that was sent to a work associate. If the request is an expiration request, decision 320 branches to “Yes” branch 324 whereupon the request is processed and an expiration request is sent to the target (pre-defined process block 325, see FIG. 6 and corresponding text for further details).

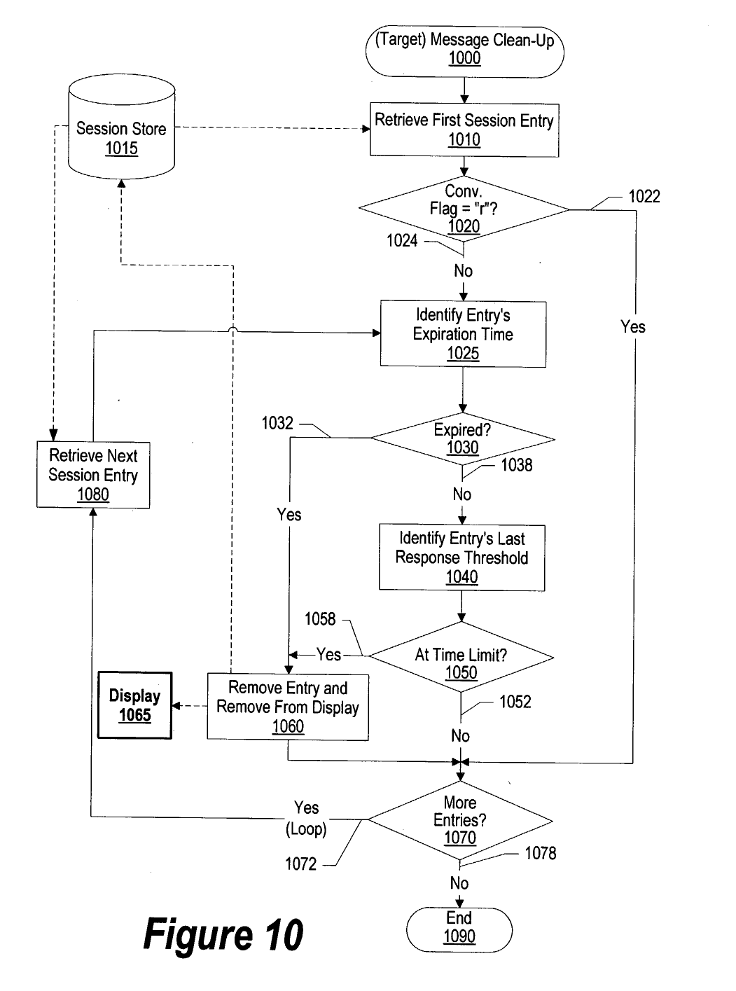

A determination is made as to whether the target has sent a reply that corresponds to an instant message or an expiration request (decision 330). For example, the target may have responded to an instant message it received from the source. In another example, the target may have received an expiration request, removed a particular number of messages, and sent an expiration acknowledgement to the source. If the source received a reply from the target, decision 330 branches to “Yes” branch 334 whereupon the target's reply is processed (pre-defined process block 335, see FIG. 9 and corresponding text for further details). On the other hand, if the source has not received a reply from the target, decision 330 branches to “No” branch 332 bypassing reply processing steps.

In one embodiment, the target sends a “target replying” notification to the source which indicates that the target is in process of replying to the instant message. The source processes the notification and removes the target's identifier from a target selection list (see FIGS. 2B, 2C, and corresponding text for further details regarding target selection lists).

A determination is made as to whether to continue source processing (decision 340). For example, source processing may continue until user 302 logs off the source. If source processing should continue, decision 340 branches to “Yes” branch 342 which loops back to process more user requests. This looping continues until source processing should halt, at which point decision 340 branches to “No” branch 344 whereupon processing ends at 345.

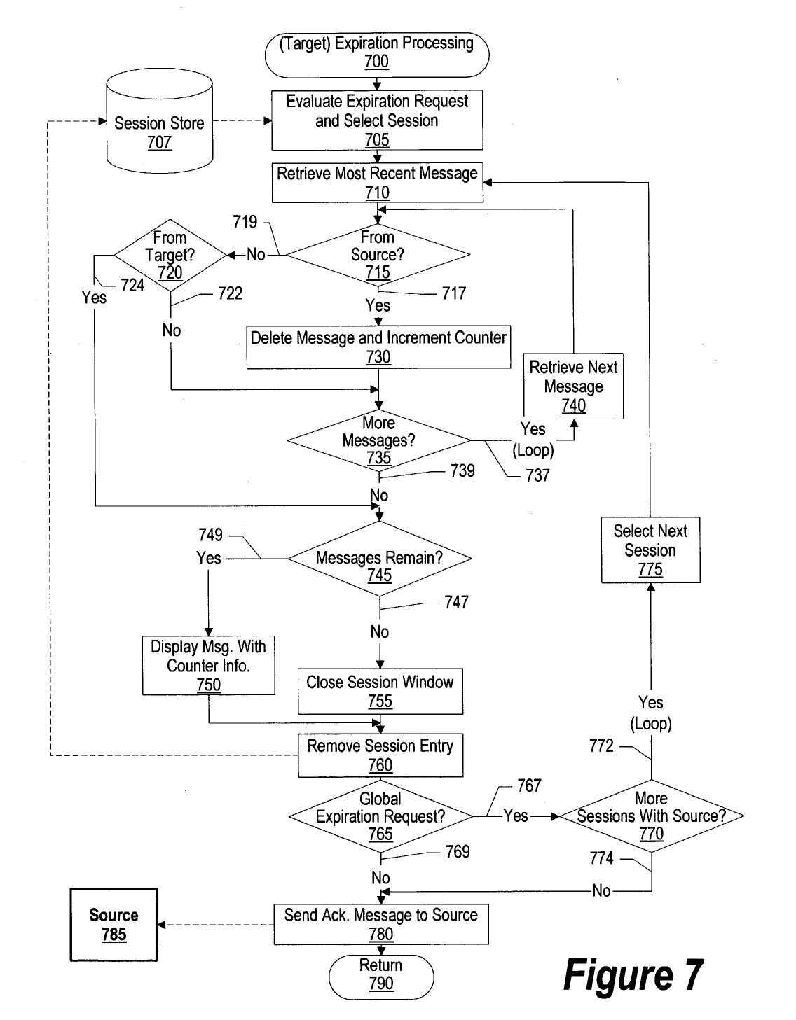

Target processing commences at 350, whereupon the target receives a request from the source at step 355. The request may be an instant message request or an expiration request. A determination is made as to whether the request is an instant message request (decision 360). If the request is an instant message request, decision 360 branches to “Yes” branch 362 whereupon the request is processed (pre-defined process block 365, see FIG. 5 and corresponding text for further details). On the other hand, if the request is not an instant message request, decision 360 branches to “No” branch 364 bypassing instant message-processing steps.

A determination is made as to whether the request is an expiration request (decision 370). For example, the source may wish to delete an instant message from the target's display. If the request is an expiration request, decision 370 branches to “Yes” branch 372 whereupon the expiration request is processed (pre-defined process block 375, see FIG. 7 and corresponding text for further details). On the other hand, if the source request is not an expiration request, decision 370 branches to “No” branch 374 bypassing expiration request-processing steps.

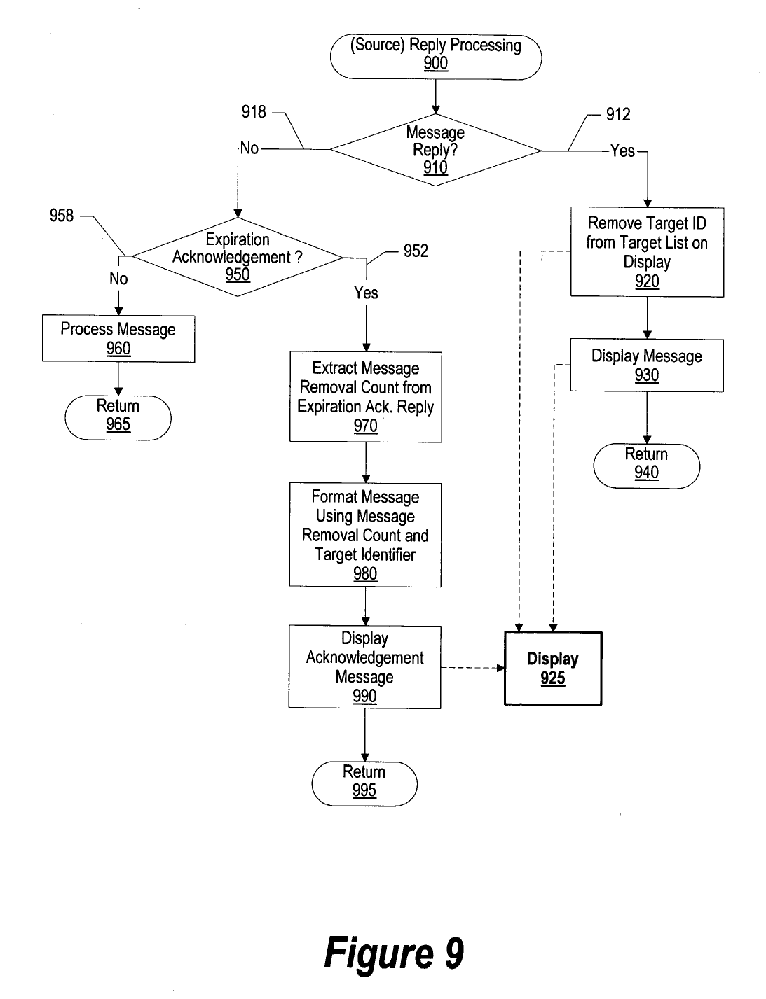

A determination is made as to whether to continue target processing (decision 385). For example, target processing may continue until the target's user (e.g. user 398) logs-off the target. If target processing should continue, decision 385 branches to “Yes” branch 382 whereupon a determination is made as to whether user 398 wishes to respond to an instant message (decision 390). For example, user 398 may have received an instant message and wishes to reply to the message. If user 398 wishes to reply to an instant message, decision 390 branches to “Yes” branch 394 whereupon processing receives user 398's reply and sends the reply to the source (pre-defined process block 395, see FIG. 8 and corresponding text for further details). On the other hand, if user 398 does not wish to reply to an instant message, decision 390 branches to “No” branch 392 bypassing message replying steps.

When target processing should halt, decision 385 branches to “No” branch 388 whereupon target processing ends at 399.

FIG. 4 is a flowchart showing steps taken in a source sending an instant message to a target. Message request processing commences at 400, whereupon the source selects a target identifier located in source store 415. For example, a user may select “Target A” in which the source retrieves “Target A's” target identifier. Processing displays a session window to user 425 at step 420. The session window includes a text box for user 425 to enter an instant message, and an “Expire” command button that may be selected to expire an instant message (see FIGS. 2A, 2B, 2C, and corresponding text for further details regarding session window properties).

Processing receives an instant message from user 425 at step 430. Processing identifies an expiration time corresponding to the instant message at step 440. An expiration time is a time when a target expires (e.g. deletes) the corresponding message if the target has not responded to the last message sent from the source. The user may provide the expiration time or the expiration time may be retrieved from user configuration data that is located in a nonvolatile storage area. The expiration time may be an absolute time, such as 12:10 PM, or the expiration time may be a relative time, such as 10 minutes after the target receives the instant message. In one embodiment, absolute expiration times are based upon an instant messaging server clock and the source and target synchronize their corresponding clocks with the instant messaging server clock.

Processing includes the instant message and the expiration time into an instant message request at step 450. For example, user 425's message may be “Hello Bill” and the message expiration time may be set at 12:10 PM. Processing stores message request properties in source store 415 in order for processing to track which instant messages a target sends a reply. Processing sends the message request to target 475 at step 470. Processing adds the identified target identifier in a target selection box located in the session window and enables the “Expire” command button at step 480. User 425 is now able to expire the instant message up until a time when target 475 responds to the instant message. Processing returns at 490.

FIG. 5 is a flowchart showing steps taken in a target processing a message that is sent by a source. Message processing commences at 500, whereupon processing evaluates the message (i.e. identify the source) at step 505. A determination is made as to whether the message belongs to an existing session between the target and the source or if the message is the start of a new session (decision 510).

If the message is part of an existing session, decision 510 branches to “Yes” branch 512 whereupon processing retrieves a conversation state flag from a session entry corresponding to the session wherein the session entry is located in target session store 528 (step 513). The conversation state flag identifier identifies whether the target has responded to the source during the instant messaging session (see FIGS. 1, 8, and corresponding text for further details regarding conversation state flag settings). Target session store 528 may be stored on a non-volatile storage area, such as a computer hard drive. A determination is made as to whether the target has responded to the source during the instant messaging session (e.g. conversation state flag equal “r”) (decision 515). If the target has replied to the source, decision 515 branches to “Yes” branch 517 bypassing session entry modification steps.

On the other hand, if the target has not responded to the source during the instant messaging session, decision 515 branches to “No” branch 519 whereupon processing extracts the message's expiration time at step 520. The expiration time is a time set by the source whereby the target deletes a corresponding message if the target has not responded to the message by the expiration time. Processing includes the message's expiration time in an existing session entry corresponding to the source at step 525.

In one embodiment, named “Message Level”, processing adds a session entry to target session store 528 for each message that is sent by a source regardless of whether the target has responded to the source during the instant messaging session.

Processing adds the new message to a message table located in target session store 528 at step 530. The message table is used to track messages that are received from various sources. For example, the message table may be an array whereby each array cell includes one message and identifies the corresponding source. Processing displays the instant message on an existing session window on display 575 at step 535 for a target's user to view.

If the new message is not part of an existing session, decision 510 branches to “No” branch 514 whereupon processing initiates a new session by entering a new session entry that includes a source identifier (step 540). The new session entry also includes a conversation flag that is reset to “n” indicating that the target has not yet replied to the message. The new session entry is stored in target session store 528.

Processing retrieves a last response threshold from user configuration store 548 at step 545. The last response threshold is a time the target removes unanswered instant messages from the target's display due to target inactivity. For example, a target's user may have configured a last response threshold for each session at “50 minutes”. If the target does not respond to new messages within 50 minutes, the new messages are automatically removed. User configuration store 548 may be stored on a non-volatile storage area, such as a computer hard drive.

Processing extracts the new message's expiration time at step 550, and includes the expiration time and last response threshold in the new session entry which is stored in target session store 528 at step 555. Processing adds new message properties to a message table located in session store 525 at step 565, and displays the new message in a new session window on display 575 at step 570. Processing returns at 580.

FIG. 6 is a flowchart showing steps taken in a source sending an expiration request to a target. Expiration request processing commences at 600, whereupon processing identifies a target identifier corresponding to the expiration request (step 610). For example, a user may wish to delete an instant message at “Target A” because “Target A” has not responded for one hour. Target identifiers are located in source store 615 and source store 615 may be stored on a non-volatile storage area, such as a computer hard drive.

Processing removes the identified target identifier from a target selection list shown on display 630 at step 620. A determination is made as to whether there are more target identifiers still existing in the target selection list (decision 640). For example, an instant messaging session may include multiple targets that have not responded to a particular message in which case more target identifiers still exist in the target selection box after the identified target identifier is removed (see FIGS. 2B, 2C, and corresponding text for further details regarding selection boxes). If no more target identifiers exist in the target selection box, decision 640 branches to “No” branch 642 whereupon processing disables an “Expire” command button shown on display 630. On the other hand, if more target identifiers exist in the target selection box, decision 640 branches to “Yes” branch 648 bypassing command button disabling steps.

Processing formats an expiration request at step 660 which includes adding the source identifier, a global expiration request (if chosen by the user), and may include a session identifier (see FIGS. 2A, 2B, 2C, and corresponding text for further details regarding global expirations). Processing sends the expiration request to target 675 at step 670. Processing logs the expiration request in source store 615 (step 680) so the source may track expiration requests corresponding to targets, and processing returns at 690.

FIG. 7 is a flowchart showing steps taken in a target processing an expiration request. Processing commences at 700, whereupon processing evaluates the request at step 705 and selects a session entry located in session store 707. Session store 707 may be stored on a non-volatile storage area, such as a computer hard drive. Expiration request evaluation may include identifying a source of the expiration request, identifying an existing session corresponding to the expiration request, and identifying a session entry corresponding to the source and the active session.

Processing retrieves a message corresponding to the active session at step 710. Processing may retrieve the message from a message table located in the target's non-volatile storage area. The message table stores information about instant messages corresponding to a particular session (see FIG. 5 and corresponding text for further details regarding message storing steps).

A determination is made as to whether the message corresponds to the source that sent the expiration request (decision 715). If the message is from the source, decision 715 branches to “Yes” branch 717 whereupon the message is deleted from the target's display and a message counter is incremented (step 730). The message counter tracks the number of messages that the target deletes in response to a particular expiration request.

On the other hand, if the message does not correspond to the source, decision 715 branches to “No” branch 719 whereupon a determination is made as to whether the message corresponds to a target's response (decision 720). If the message is a response from the target, decision 720 branches to “Yes” branch 724 and processing exits message evaluation steps. On the other hand, if the message does not correspond to a target's response, the message corresponds to a client other than the source or the target and decision 720 branches to “No” branch 722 bypassing message deletion steps.

A determination is made as to whether there are more messages corresponding to the selected session (decision 735). If there are more messages corresponding to the selected session, decision 735 branches to “Yes” branch 737 which loops back to retrieve (step 740) and process the next message. This looping continues until there are no more messages to process, at which point decision 735 branches to “No” branch 739.

A determination is made as to whether messages remain in the session window (e.g. other client messages or target messages). If messages remain in the session window, decision 745 branches to “Yes” branch 749 whereupon processing displays a message in the session window indicating the number of messages that were deleted along with a source identifier that sent the expiration request (step 750). On the other hand, if no messages remain in the session window, decision 745 branches to “No” branch 747 whereupon processing closes the session window at step 755. In one embodiment, processing displays a message on the target's display indicating the number of messages that were deleted and a source identifier that sent the expiration request.

Processing removes the session entry from session store 707 at step 760. In one embodiment, session entries may be configured in a “Message Level” mode corresponding to a particular source. In a “Message Level” mode, a session entry is included in session store 707 for each instant message that was sent by a source. In this embodiment, processing removes each session entry associated with a message that is removed.

A determination is made as to whether the expiration request is a global expiration request (decision 765). A global expiration request is a request for the target to remove eligible messages received from the source for each active session instead of a particular session (see FIGS. 2A, 2B, 2C, and corresponding text for further details regarding global expiration requests).

If the expiration request is not a global expiration request, decision 765 branches to “No” branch 769 whereupon processing sends an acknowledgement message to source 785 that includes the number of messages deleted by the target (step 780). In one embodiment, in addition to the source indicating the number of messages that were deleted at the target, corresponding messages in the source session window are changed to an “expired” color, such as red, that indicate at the source which messages were deleted at the target. In another embodiment, the source displays a system message outside of the session window's message area, such as a status bar, to indicate to the source's user that messages were deleted at the target.

On the other hand, if the expiration request is a global expiration request, decision 765 branches to “Yes” branch 767 whereupon a determination is made as to whether the target has more active sessions with the source (decision 770). If the target has more active sessions with the source, decision 770 branches to “Yes” branch 772 which loops back to select (step 775) and process the next session. This looping continues until there are no more active sessions to process, at which point decision 770 branches to “No” branch 774 whereupon processing sends an acknowledgement message to source 785 that includes the number of messages that were deleted by the target (step 780). Processing returns at 790.

FIG. 8 is a flowchart showing steps taken in a target replying to an instant message. Processing commences at 800, whereupon a response notification is sent to source 820 which informs the source that the target is in process of replying to a particular instant message (step 810). Processing identifies a session entry corresponding to source 820 located in session store 860 (step 830). Session store 860 may be stored on a non-volatile storage area, such as a computer hard drive. A determination is made as to whether the reply is the target's first reply to the source a particular session by evaluating the session entry's conversation state flag (decision 840). For example, the target may have received multiple messages from source 830 but the target's user was in a meeting for two hours and has not responded to source 830.

If the reply is the first reply for a particular session, decision 840 branches to “Yes” branch 842 whereupon processing removes an expiration time, removes a last response threshold, and changes a conversation state flag included in the session entry to “r” which indicates that the target has replied to source 830 (step 870).

Processing receives instant messaging text from target's user 885 at step 880, sends the instant message to source 830 at step 890, and processing returns at 895.

FIG. 9 is a flowchart showing steps taken in a source processing a target's reply. Reply processing commences at 900, whereupon a determination is made as to whether the target's reply is an instant message reply (decision 910). For example, the target may have sent a reply to an instant message that the source sent to the target.

If the reply is an instant message reply, decision 910 branches to “Yes” branch 912 whereupon processing removes the target's corresponding target identifier from a target selection list shown on display 925 at step 920 (see FIGS. 2B, 2C and corresponding text for further details regarding target identifiers). Processing displays the instant message on display 925 at step 930, and processing returns at 940.

On the other hand, if the target's reply is not an instant message reply, decision 910 branches to “No” branch 918 whereupon a determination is made as to whether the target reply is an expiration acknowledgement (decision 950). For example, the source may have sent an expiration request to the target to remove an instant message from the target's display and the target has sent an expiration acknowledgement to the source confirming that the message was removed. If the target reply is not an expiration acknowledgement, decision 950 branches to “No” branch 958 whereupon the source processes the message at step 960, and processing returns at 965.

On the other hand, if the target reply is an expiration acknowledgement, decision 950 branches to “Yes” branch 952 whereupon processing extracts a message removal count from the target reply at step 970. The message removal count corresponds to the number of messages that the target removed from the target's display while processing the source's expiration request (see FIG. 7 and corresponding text for further details regarding message removal counts). Processing formats an acknowledgement message which includes the message removal count and the target identifier at step 980, and displays the acknowledgement message on display 925 at step 990 to inform the source's user that the user's instant messages were deleted at the target. Processing returns at 995.

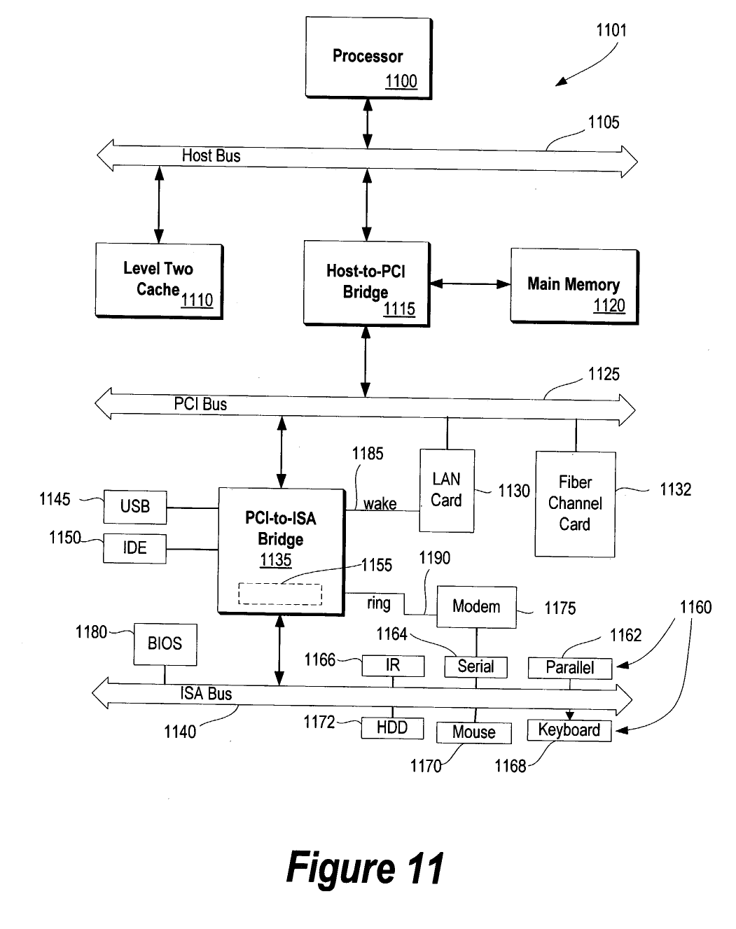

FIG. 10 is a flowchart showing steps taken in a target processing existing session entries and removing session entries that have expired. The steps taken in the flowchart may be performed for each active session at the target and may be scheduled on a regular basis, such as every minute. Processing commences at 1000, whereupon processing retrieves a first session entry from session store 1015 at step 1010. A session entry may include a source identifier, an expiration time, a last response threshold, and a conversation state flag. The source identifier identifies a client that sent a corresponding instant message. The expiration time is a time set by the source in which a corresponding message should be removed from the target's display if the target has not responded to the instant message. The last response threshold is a time set by the target in which the corresponding message should be removed from the target's display if the target has not responded to the instant message. The conversation state flag is set to “n” for “not replied” until the target replies to a corresponding instant message, at which point the conversation state flag is set to “r” for replied.

A determination is made as to whether the target has replied to the first session entry's source (decision 1020). If the target has replied to the first session entry's source, decision 1020 branches to “Yes” branch 1022 bypassing expiration analysis steps. On the other hand, if the target has not replied to the first session entry's source, decision 1020 branches to “No” branch 1024 whereupon processing identifies the session entry's expiration time (step 1025). A determination is made as to whether the expiration time has been reached (decision 1030). If the expiration time has been reached, decision 1030 branches to “Yes” branch 1032 whereupon the session entry is removed from session store 1015 and messages corresponding to the session entry are removed from display 1065 (step 1060).

In one embodiment, session entries may be configured in a “Message Level” mode corresponding to a particular source. In a “Message Level” mode, a session entry is included in session store 1015 for each instant message that was sent by a source. In this embodiment, processing removes each session entry associated with a message that is being removed.

On the other hand, if the expiration time has not been reached, decision 1030 branches to “No” branch 1038 whereupon processing identifies the session entry's last response threshold at step 1040. A determination is made as to whether the last response threshold has been reached (decision 1050). If the last response threshold has been reached, decision 1050 branches to “Yes” branch 1058 whereupon the session entry is removed from session store 1015 and messages corresponding to the session entry are removed from display 1065 (step 1060).

On the other hand, if the last response threshold limit has not been reached, decision 1050 branches to “No” branch 1052 whereupon a determination is made as to whether there are more session entries to process (decision 1070). For example, the instant messaging session may have four source participants and session store 1015 includes a separate session entry for each source participant. If there are more session entries to process, decision 1070 branches to “Yes” branch 1072 which loops back to retrieve (step 1080) and process the next session entry. This looping continues until there are no more session entries to process, at which point decision 1070 branches to “No” branch 1078 whereupon processing ends at 1090.

FIG. 11 illustrates information handling system 1101 which is a simplified example of a computer system capable of performing the invention described herein. Computer system 1101 includes processor 1100 which is coupled to host bus 1105. A level two (L2) cache memory 1110 is also coupled to the host bus 1105. Host-to-PCI bridge 1115 is coupled to main memory 1120, includes cache memory and main memory control functions, and provides bus control to handle transfers among PCI bus 1125, processor 1100, L2 cache 1110, main memory 1120, and host bus 1105. PCI bus 1125 provides an interface for a variety of devices including, for example, LAN card 1130. PCI-to-ISA bridge 1135 provides bus control to handle transfers between PCI bus 1125 and ISA bus 1140, universal serial bus (USB) functionality 1145, IDE device functionality 1150, power management functionality 1155, and can include other functional elements not shown, such as a real-time clock (RTC), DMA control, interrupt support, and system management bus support. Peripheral devices and input/output (I/O) devices can be attached to various interfaces 1160 (e.g., parallel interface 1162, serial interface 1164, infrared (IR) interface 1166, keyboard interface 1168, mouse interface 1170, and fixed disk (HDD) 1172) coupled to ISA bus 1140. Alternatively, many I/O devices can be accommodated by a super I/O controller (not shown) attached to ISA bus 1140.

BIOS 1180 is coupled to ISA bus 1140, and incorporates the necessary processor executable code for a variety of low-level system functions and system boot functions. BIOS 1180 can be stored in any computer readable medium, including magnetic storage media, optical storage media, flash memory, random access memory, read only memory, and communications media conveying signals encoding the instructions (e.g., signals from a network). In order to attach computer system 1101 to another computer system to copy files over a network, LAN card 1130 is coupled to PCI bus 1125 and to PCI-to-ISA bridge 1135. Similarly, to connect computer system 1101 to an ISP to connect to the Internet using a telephone line connection, modem 1175 is connected to serial port 1164 and PCI-to-ISA Bridge 1135.

While the computer system described in FIG. 11 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of removing a message from a display, said method comprising:
receiving, at a target computer system, the message from a source;
displaying the message in a session window in response to the receiving;
detecting an expiration request from the source; and
removing the message from the session window in response to the expiration request.

2. The method as described in claim 1 wherein the receiving further comprises:
determining whether the message corresponds to an existing session; and
generating a session entry in response to the determination, wherein the session entry includes one or more session entry fields.

3. The method as described in claim 2 wherein at least one of the session entry fields is selected from the group consisting of a source identifier, an expiration time, a last response threshold, and a conversation state flag.

4. The method as described in claim 1 further comprising:
determining whether the target computer system has responded to the message; and
closing the session window in response to the determination.

5. The method as described in claim 1 wherein the expiration request corresponds to an expiration time, the method further comprising:
determining that the expiration time has expired; and
performing the removing in response to the determination.

6. The method as described in claim 1 further comprising:
sending an acknowledgement message to the source wherein the acknowledgement message corresponds to the removal of the message.

7. The method as described in claim 1 wherein the expiration request is generated at the source, the method further comprising:
receiving, at the source, a user request;
identifying a target identifier corresponding to the user request, the target identifier corresponding to the target computer system; and
generating the expiration request in response to the identifying.

8. The method as described in claim 1 wherein the expiration request is received subsequent to the message.

9. An information handling system comprising:
one or more processors;
a memory accessible by the processors;
a display device;
one or more nonvolatile storage devices accessible by the processors; and
a message removal tool to remove a message from the display device, the message removal tool including:
reception logic for receiving, at a target computer system, the message from a source;
display logic for displaying the message in a session window on the display device in response to the receiving;
detection logic for detecting an expiration request from the source; and
removal logic for removing the message from the session window on the display device in response to the expiration request.

10. The information handling system as described in claim 9 wherein the receiving further comprises:
detection logic for determining whether the message corresponds to an existing session; and
generation logic for generating a session entry in response to the determination, wherein the session entry is stored in one of the nonvolatile storage devices and includes one or more session entry fields.

11. The information handling system as described in claim 10 wherein at least one of the session entry fields is selected from the group consisting of a source identifier, an expiration time, a last response threshold, and a conversation state flag.

12. The information handling system as described in claim 9 wherein the expiration request corresponds to an expiration time, the information handling system further comprising:
determination logic for determining that the expiration time has expired; and
initiation logic for initiating the removing in response to the determination.

13. The information handling system as described in claim 9 further comprising:
transmission logic for sending an acknowledgement message to the source over a computer network wherein the acknowledgement message corresponds to the removal of the message from the display device.

14. The information handling system as described in claim 9 wherein the expiration request is generated at the source, the information handling system further comprising:
reception logic for receiving, at the source, a user request;
identification logic for identifying a target identifier corresponding to the user request, the target identifier corresponding to the target computer system; and
generation logic for generating the expiration request in response to the identifying.

15. A computer program product stored on a computer operable media for removing a message from a display, said method comprising:
means for receiving, at a target computer system, the message from a source;
means for displaying the message in a session window in response to the receiving;
means for detecting an expiration request from the source; and
means for removing the message from the session window in response to the expiration request.

16. The computer program product as described in claim 15 wherein the receiving further comprises:
means for determining whether the message corresponds to an existing session; and
means for generating a session entry in response to the determination, wherein the session entry includes one or more session entry fields.

17. The computer program product as described in claim 16 wherein at least one of the session entry fields is selected from the group consisting of a source identifier, an expiration time, a last response threshold, and a conversation state flag.

18. The computer program product as described in claim 15 further comprising:
means for determining whether the target computer system has responded to the message; and
means for closing the session window in response to the determination.

19. The computer program product as described in claim 15 wherein the expiration request corresponds to an expiration time, the computer program product further comprising:
means for determining that the expiration time has expired; and
means for performing the removing in response to the determination.

20. The computer program product as described in claim 15 further comprising:
means for sending an acknowledgement message to the source wherein the acknowledgement message corresponds to the removal of the message.

21. The computer program product as described in claim 15 wherein the expiration request is generated at the source, the computer program product further comprising:
means for receiving, at the source, a user request;
means for identifying a target identifier corresponding to the user request, the target identifier corresponding to the target computer system; and
means for generating the expiration request in response to the identifying.

22. A method of removing a message from a display, said method comprising:
receiving, at a target computer system, the message from a source, wherein the receiving further comprises:
determining whether the message corresponds to an existing session; and
generating a session entry in response to the determination, wherein the session entry includes one or more session entry fields;
displaying the message in a session window in response to the receiving;
detecting an expiration request from the source; and
removing the message from the session window in response to the expiration request.

23. A method of removing a message from a display, said method comprising:
receiving, at a target computer system, the message from a source;
displaying the message in a session window in response to the receiving;
detecting an expiration request from the source;
removing the message from the session window in response to the expiration request; and
sending an acknowledgement message to the source wherein the acknowledgement message corresponds to the removal of the message.

24. An information handling system comprising:
one or more processors;
a memory accessible by the processors;
a display device;
one or more nonvolatile storage devices accessible by the processors; and
a message removal tool to remove a message from the display device, the message removal tool including:
reception logic for receiving, at a target computer system, the message from a source;
display logic for displaying the message in a session window on the display device in response to the receiving;
detection logic for detecting an expiration request from the source;
removal logic for removing the message from the session window on the display device in response to the expiration request; and
transmission logic for sending an acknowledgement message to the source wherein the acknowledgement message corresponds to the removal of the message.

25. A computer program product stored on a computer operable media for removing a message from a display, said method comprising:
means for receiving, at a target computer system, the message from a source;
means for displaying the message in a session window in response to the receiving;
means for detecting an expiration request from the source;
means for removing the message from the session window in response to the expiration request; and
means for sending an acknowledgement message to the source wherein the acknowledgement message corresponds to the removal of the message.
